(19) United States
(12) Patent Application Publication
(10) Pub. No.: US 2017/0097486 A1
(43) Pub. Date: Apr. 6, 2017

(54) HARDENED DROP TERMINAL AND CLAMPSHELL

(71) Applicant: COMMUNICATIONS SYSTEMS, INC., Minnetonka, MN (US)

(72) Inventors: Armando Barrantes, Alajuela (CR); Federico Lopez Zamora, San Lorenzo de Flores (CR); George I. Wakileh, Batavia, IL (US); Alexander Abarca, San Francisco de Heredia (CR)

(73) Assignee: Communications Systems, Inc., Minnetonka, MN (US)

(21) Appl. No.: 15/314,283

(22) PCT Filed: May 19, 2015
(86) PCT No.: PCT/US2015/031489

§ 371 Date: Nov. 28, 2016

Related U.S. Application Data
(60) Provisional application No. 62/003,166, filed on May 27, 2014.

(51) Int. Cl. G02B 6/44; G02B 6/38

(52) U.S. Cl. CPC G02B 6/445; G02B 6/4477; G02B 6/3897; G02B 6/4457

(57) ABSTRACT

A fiber optic cable network interface device includes a base unit defining an interior cavity. The device has a cable entrance port for a main fiber optic cable having a plurality of individual fiber optic cables and at least one cable exit port for at least one distribution fiber optic cable. The cable exit port includes a first portion of a retaining mechanism. The device includes a bulkhead connector retained to the base unit wherein the bulkhead connector is configured to connect the main cable to one of the one of the cables of the main cable to a distribution cable. The device includes a clampshell that engages the distribution fiber optic cable and transition a jacketing of the distribution fiber optic cable from an interior jacket to an exterior jacket wherein an exterior surface of the clampshell comprises a second portion of the retaining mechanism.

### BACKGROUND

Disclosed embodiments relate to a hardened drop terminal and clampshell that can be utilized in a fiber optic cable distribution network on a central office side of a telecommunications network. More particularly, the disclosed embodiments relate to a hardened drop terminal and clampshell that minimizes or limits tensile and rotational stresses that are placed on fiber optic cable connections within the hardened drop terminal on the central office side of the telecommunications network.

The telecommunications industry commonly utilizes a fiber optic network to transmit data. A fiber optic telecommunications network typically has a backbone or feed fiber optic cable that supports communications to and from branch or secondary fiber optic cable networks. The backbone or main fiber optic cable has a plurality of individual cables along with strengthening members that are contained within a heavy sheath.

A typical fiber optic cable that is used outdoors and is exposed to the environment includes a heavy and stiff jacket that makes manipulating and positioning the fiber optic cable difficult. When a portion of the fiber optic cable is positioned within an enclosure, the heavy and stiff jacket is typically stripped from the fiber optic cable and replaced with an interior jacket that is more lightweight and flexible jacket compared to the heavy and stiff outdoor rated jacket. The interior jacket allows the fiber optic cable to be more easily manipulated and worked with. The interior jacket can be rated for indoor applications and/or outdoor applications.

A common location where a fiber optic network experiences failure is at a distribution junction from the backbone or main cable to fiber optic networks that branch from the backbone or main cable on the central office side of the fiber optic network. A typical location of the distribution junction is at telecommunications pole for overhead fiber optic networks and at a pedestal for buried fiber optic networks. This failure is typically caused by tensile or rotational stresses at the connection between the individual feed fiber optic cables of the backbone or feed fiber optic cable and the individual branch fiber optic distribution fiber optic cables.

The discussion above is merely provided for general background information and is not intended to be used as an aid in determining the scope of the claimed subject matter.

### SUMMARY

Disclosed is an exemplary embodiment of a clampshell that transitions a jacketing of an individual fiber optic cable from a heavy and stiff jacket that is rated for outdoor use to a more flexible and lightweight interior jacket that is rated for either indoor use or outdoor use. It is also contemplated that the clampshell is capable of transitioning one fiber optic cable to another fiber optic cable with a splice connection, such as a fusion splice or a mechanical splice. The clampshell has hingedly connected housing halves that are positionable between an open position and a closed position. The housing halves are typically constructed of a rigid material, such as a high-density polymer. Each of the housing halves includes an inner surface that defines an interior cavity when the housing halves are positioned into the closed position. The housing halves have open opposing first and second ends that are sized to allow the fiber optic cable having the different types of jacketing to be positioned within the interior cavity. The clampshell includes at least one strain relief that has a through bore sized to pass the fiber optic cable with the interior jacket therethrough. The strain relief is constructed of a compressible material and has an outer surface configured to fit into the interior cavity proximate the first end. The strain relief has an outer diameter that is greater than a diameter of the inner cavity when the halves are positioned into the substantially closed position. Outer surfaces of the housing halves have cooperating threads at the opposing first and second ends when the housing halves are in a substantially closed position such that the threaded surfaces are configured to accept a threaded nut. As a nut is threaded onto the outer surface through a threaded engagement proximate the first end, the housing halves are forced together which causes the strain relief to compress and frictionally engage the interior jacketed fiber optic cable. The frictional engagement between the strain relief and the interior jacketed fiber optic cable provides strength to the cable within the strain relief. A second end of the clampshell includes opposing cutouts that accept the heavy and stiff jacketed, flat fiber optic cable while having a sufficient diameter to accept a round heavy and stiff jacketed fiber optic cable to pass therethrough. A second nut is threadably secured to the second end and causes the second ends of the two halves to frictionally engage the heavy and stiff jacketed fiber optic cable portion and retain the interior jacketed cable portion. The engagement between the nuts and the threaded outer surfaces at the first and second ends seal the clampshell such that the clampshell is water-resistant.

Disclosed is an exemplary embodiment of a hardened drop terminal for connecting fiber optic cables on a central office of a telecommunications fiber optic network, typically at a telecommunications pole for overhead fiber optic cables or at a pedestal for underground or buried telecommunication fiber optic distribution cables. The hardened drop terminal includes a base unit having an entrance port for a backbone or main telecommunications cable from central office side of the telecommunications fiber optic network cable. The hardened drop terminal includes a clamp to secure the sheathed telecommunications fiber optic network within an interior cavity and allows a length of the fiber optic cable(s) to be exposed that extend beyond the clamp. The hardened drop terminal also includes a bulkhead connector having one or more paired receptacles that couple one or more the fiber optic cables from the backbone or main fiber optic cables on a first side to one or more fiber optic cable distribution cables on the second side of the bulkhead connector. The fiber optic distribution cables include one or more drop cables having a proximal end connected to the second of the bulkhead connector. The drop cables are typically jacketed with an interior jacket rated for interior use or outdoor use where the jacket is flexible which allows the fiber optic cable to be more easily worked with. A length of the drop cable is jacketed with the interior jacket such that drop cable with the interior jacket is located proximate a wall of the hardened drop terminal. A clampshell is configured to engage and frictionally secure the interior jacketed drop cable while providing strength and strain relief of the drop cable. The clampshell also transitions the drop cable from the interior jacket to a rigid and stiff jacket that is rated for outdoor use. An outer surface of the clampshell includes at least one tongue having a flat surface and at least one groove having a flat surface. The tongue and groove in the clampshell engage corresponding grooves and tongues in a slot within the base unit such that the interaction between the corresponding tongues and grooves prevent rotation of the clampshell relative to the hardened drop terminal such that rotational stresses are minimized at the connection of the drop cable to the bulkhead connector while also preventing pulling forces or tensile stresses from being placed upon the drop cable and thereby increasing the reliability of the fiber optic telecommunications network on the central office side of the telecommunications network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a perspective view of a hardened drop terminal with a cover in a closed position.

FIG. 2 is another perspective view of the hardened drop terminal with the cover in a closed position.

FIG. 3 is another perspective view of the hardened drop terminal with the cover in an open position and illustrating a splice tray and some fiber optic components.

FIG. 4 is another perspective view of the hardened drop terminal with the cover in an open position with the splice tray removed and illustrating some of the fiber optic components within the hardened drop terminal.

FIG. 5 is an enlarged view of the bottom portion of the hardened drop terminal in FIG. 4 and illustrating a plurality of clampshells retained within a plurality of slots in a wall of the hardened drop terminal.

FIG. 6 is an enlarged view of the top portion of the hardened drop terminal in FIG. 4 and illustrating a plurality of reels and a bulkhead connector.

FIG. 7 is a perspective view of a clampshell in a closed position.

FIG. 8 is an exploded perspective view of one embodiment of the clampshell.

FIG. 9 is an exploded perspective view of the embodiment of the clampshell with an end of a drop cable positioned within an adapter in a base of the clampshell.

FIG. 10 is an exploded perspective view of the embodiment of the clampshell with an end of a fiber optic drop cable with a stiff, flat jacket positioned within the clampshell.

FIG. 11 is a perspective view in an open position with an end of a fiber optic drop cable with a round jacket positioned within the clampshell.

FIG. 12 is a perspective view of the clampshell having a fiber optic cable retained therein with top and bottom nuts detached from the clampshell.

FIG. 13 is a perspective view of clampshell transitioning a drop cable from an outdoor jacket to an interior jacket.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Unless specified or limited otherwise, directional terms, such as “upper,” “lower,” “left,” “right,” “above,” and “below,” are used herein to allow elements of the present disclosure to be described in spatial terms, and are non-limiting as other spatial arrangements of the disclosed elements are contemplated.

Disclosed embodiments include a hardened drop terminal which couples individual fiber optic cables of a backbone or main fiber optic cable to individual distribution fiber optic cables on central office side of a telecommunications network. The hardened drop terminal cooperates with a clampshell that transitions a drop cable jacketed with a lightweight and flexible interior jacket to a heavy and relative rigid jacket that is suitable for outdoor applications. The transition of the jacketing of individual fiber optic cables from the interior jacketing to the heavy and rigid outdoor rated jacketing within the clampshell, where the clampshell cooperates with the housing of the hardened drop terminal, minimizes tensile stresses at a connection between the drop cable and the individual fiber optic cable of the backbone or main fiber optic cable. An engagement of an outer surface of the clampshell with a surface on the housing of the hardened drop terminal also minimizes rotational stresses at the connection of the drop cable to the individual fiber optic cable of the backbone or main fiber optic cable.

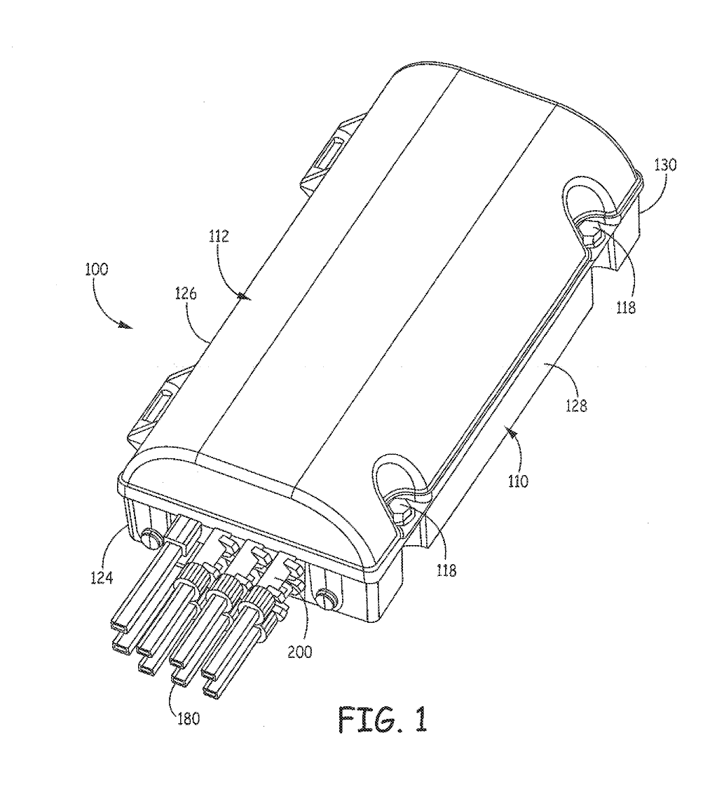

Referring now to FIG. 1, shown is a diagrammatic illustration of a hardened drop terminal 100 in accordance with exemplary embodiments. The hardened drop terminal 100 mounts at a desired location, typically a telecommunications pole for overhead telecommunication networks and a pedestal for underground or buried telecommunications networks. However, the hardened drop terminal 100 is not limited to use in this type of application.

Referring to FIGS. 1-4, the hardened drop terminal 100 includes a base unit 110 and a door or cover 112 which has a hinged connection to the base unit 110. Top and bottom security screw housings 116 are formed with or in the cover 112 where each security screw housing 116 is positioned through an aperture 115 and 117, respectively, in the base unit 110 when the door or cover 112 is in a closed position relative to the base unit 110. A security screw 118 is positioned through each of the top and bottom security screw housings 116 to secure the cover 112 in the closed position and deny entry into the hardened drop terminal 100 to persons without a proper tool. When in a closed position, the base unit 110 and the cover 112 form a weather-proof seal through compression of a gasket 109 about a perimeter of the base unit 110 and the cover 112 such that the gasket 109 prevents moisture from entering an interior space of the hardened drop terminal 100. In an exemplary embodiment the cover 112 and the base unit 110, excluding the security screws 118 and the gasket 109, are formed of a plastic material that prevents moisture from penetrating into the interior space of the hardened drop terminal 100.

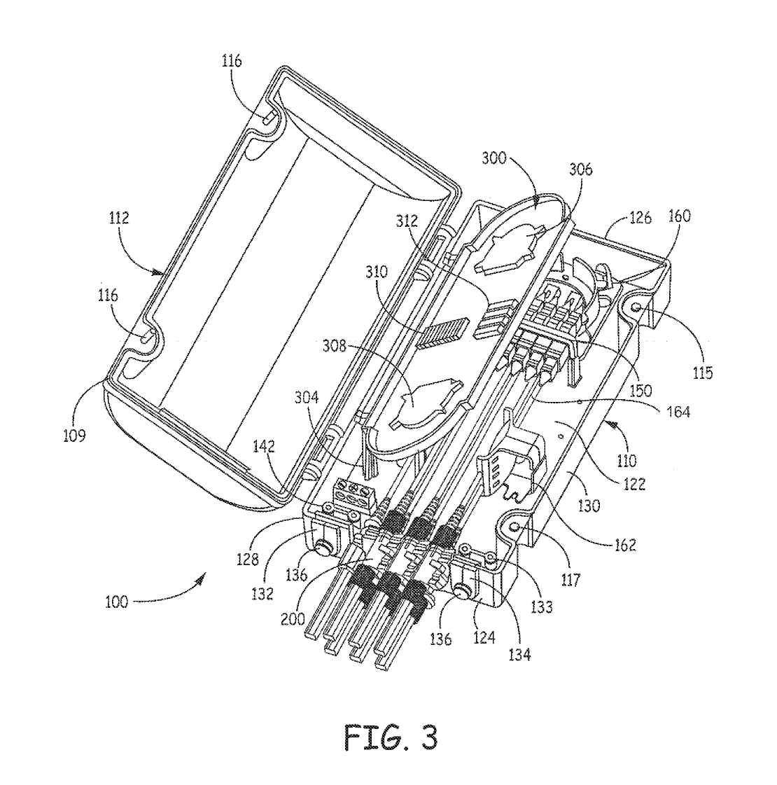

Referring to FIGS. 3-6, the base unit 110 includes back wall 122 defined by a perimeter. Extending from the perimeter of the back wall 122 are a bottom wall 124, a top wall 126, a left wall 128 and a right wall 130 where the walls 124-130 are connected together to form a continuous sidewall about the perimeter of the back wall 122. The bottom wall 124 includes a left cable entrance port 132 and a right cable entrance port 134. Each of the cable entrance ports 132 and 134 has a grommet 136 that allows a backbone or main sheathed fiber optic cable from the central office to be positioned therethrough.

Typically, only one cable entrance port 132 or 134 is necessary. However in some instances both cable entrance ports 132 and 134 can be required. One such instance when both cable ports 132 and 134 are necessary is when a mid-sheath entrance is utilized. When a mid-sheath entrance is utilized, the backbone or main fiber optic cable from the central office is secured through a port, typically port 132. A selected number of the individual fiber optic cables from the backbone or main cable from the central office are utilized in the hardened drop terminal 100 and the remaining number of sheathed individual fiber optic cables of the backbone or main fiber optic cable are then first secured in a clamp 133 and then exit the hardened drop terminal 100, typically through the port 134.

In a typical configuration the fully sheathed backbone or main cable from the central office is positioned through the grommet 136 in the cable entrance port 132 and through an opening 140 in a clamp 143 that is secured to the back wall 122 of the hardened drop terminal 100. With the cable positioned within the opening 140, the clamp 143 is manipulated to constrict the opening 140 with left and right screws and thereby frictionally retaining the fully sheathed backbone or main cable from the central office within the clamp 143. However, other clamping mechanisms or securing mechanisms besides the illustrated clam 143 are also contemplated.

The sheathing is then removed to expose the individual fiber optic cables and strengthening members in the backbone or main cable from the central office. The strengthening members are typically constructed from fiberglass or metal and prevent the cable from being excessively bent and also to provide structural integrity to the fiber optic cable. A fiber optic cable can be damaged when excessively bent, which can limit the effectiveness of the cable in the transmission of data and the strengthening members minimize this type of damage.

The strengthening members are typically cut or snipped to a selected length such that ends of the strengthening members can be positioned within through bores 144 in a securing mechanism 146 attached to and extending from the back wall 122 of the hardened drop terminal 100 with a screw 147. Screws 148 are then manipulated through threaded bores in communication with the through bores 144 to frictionally secure the strengthening members between a surface defining one of the through bores 144 and an end of the screw 148 where typically one strengthening member is secured within each of the through bores 144.

While a securing mechanism 146 having two through bores 144 is illustrated, it is also contemplated that a securing member 146 with any number of through bores could be utilized. It is also contemplated that the hardened drop terminal 100 could be utilized without the securing mechanism 146.

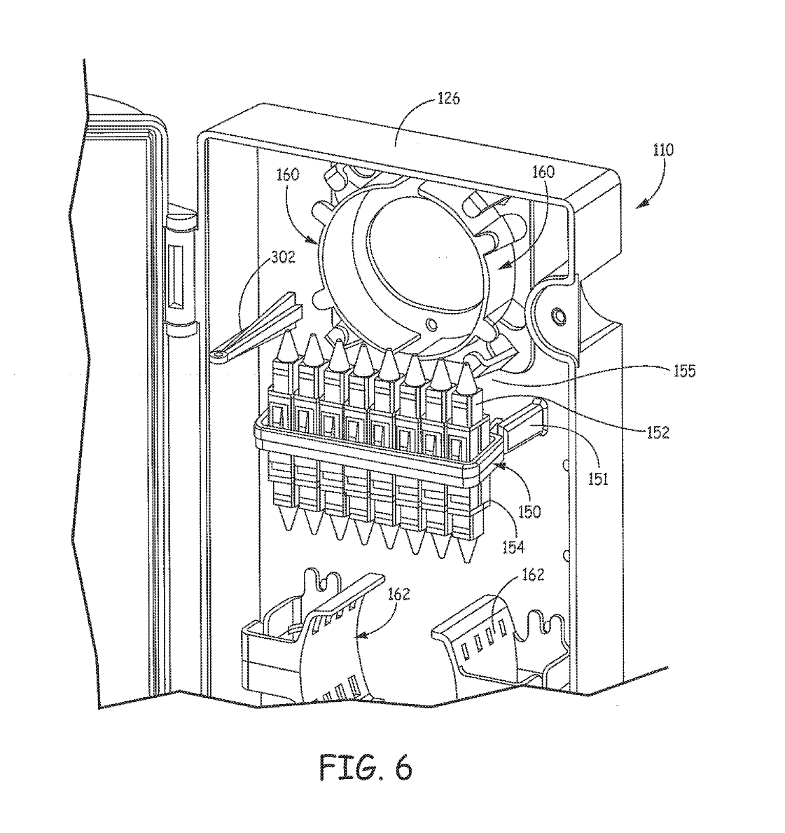

Referring to FIG. 6, the individual cables of the bundled backbone or main cable from the central office are then positioned proximate the top wall 126 of the hardened drop terminal 100 such the ends of the individual cables of the bundled cable from the central office are located proximate a bulkhead connector 150 positioned proximate the top wall 126. The bulkhead connector 150 includes a plurality of receptacles that accepts a prefabricated connector, such as, but not limited to a SC connector, on a first side 152 of the bulkhead connector 150. The bulkhead connector 150 includes a second side 154 having a plurality of receptacles that accept another connector, such as, but not limited to, a SC connector. Pairs of receptacles on each side 152 and 154 of the bulkhead connector 150 are coupled together to transmit data on the central office side of the telecommunications network.

The bulkhead connector 150 is connected to the back wall 122 with left and right spacers 151 (one of which is illustrated in FIG. 6) that are attached to the backwall 122 and proximate opposing ends of the bulkhead connector 150. A length of the spacers 151 defines a gap 155 between the back wall 122 and the bulkhead connector 150.

Extending from the back wall 122 are a plurality of arcuate storage clips 160 that act as a reel for storing excess length of cable. As the fiber optic cables are typically prefabricated at a factory and include a selected connector, the storage clips 160 allow the excess length to be spooled around the clips 160 and stored without harming the fiber optic cable.

Further, the gap 155 between the bulkhead connector 150 and the back wall 122 provides better access to the storage clips 160 to better allow for management of the excess length of fiber optic cable relative to locating the bulkhead connector 150 proximate the back wall 122.

A second plurality of arcuate storage clips 162 extend form the back wall 122 and are located between the bulkhead adaptor 150 and the bottom wall 124. The second plurality of storage clips 162 act as a reel similar to that of the storage clips 160 to allow excess length of fiber optic cable to be stored without harming the fiber optic cable.

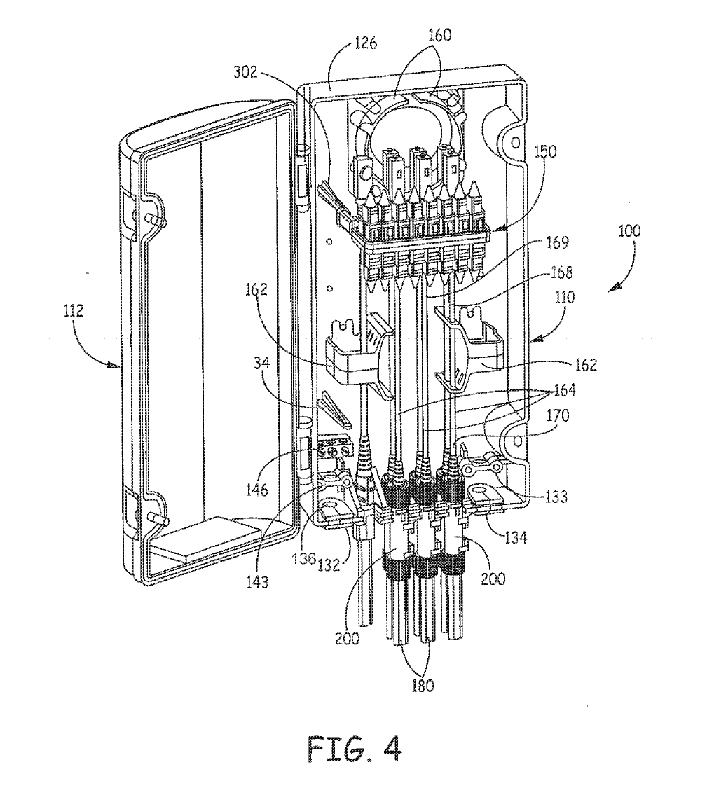

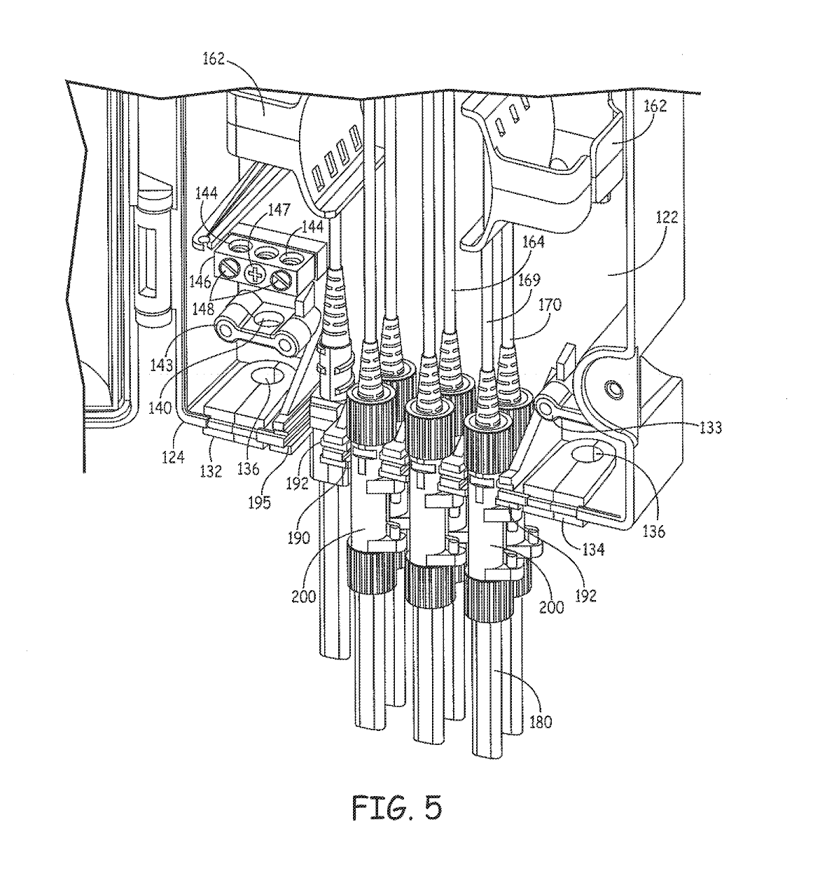

Referring to FIGS. 4 and 5, a top end 168 of a plurality of drop cables 164 are coupled to the bulkhead adaptor 150 on the second side 154. The drop cables 164 are jacketed with a length of an interior jacket 169 such that a bottom end 170 is located proximate the bottom wall 124 of the base unit 110. The bottom ends 170 of the interior jackets 169 are secured within an interior cavity of a clampshell 200, which is described in more detail herein.

The clampshell 200 transitions the drop cables 164 from the interior lightweight and flexible jacket to a heavy and rigid jacket 180 that is suitable for outdoor applications. It is also contemplated that the clampshell 200 provide strength and support to splices of the drop cable 164 to a distribution fiber optic cable, such as but not limited to a fusion splice and a mechanical splice. The clampshell 200 provides a water-resistant closure that increases the uptime and reliability of the telecommunications network.

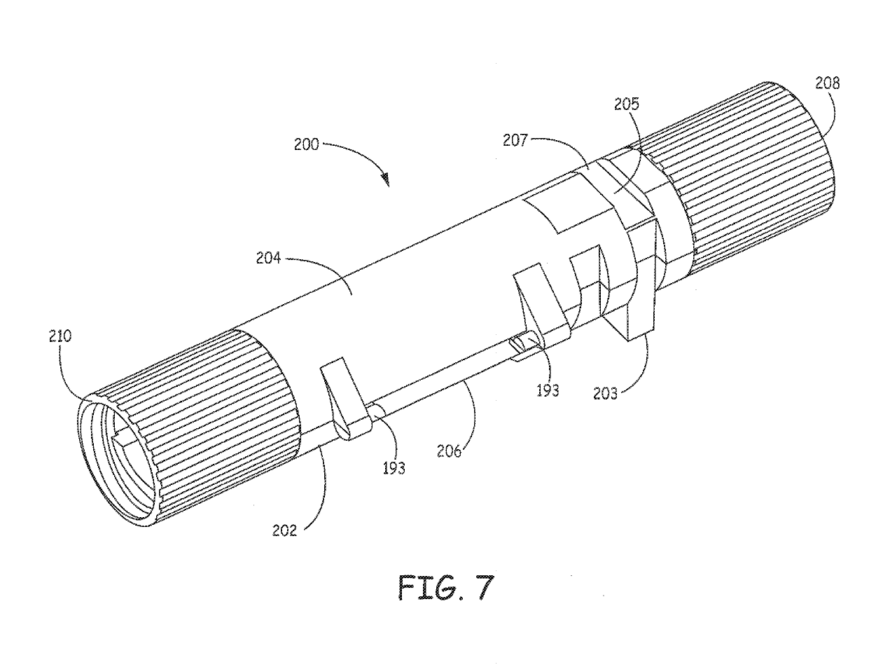

Referring to FIGS. 5 and 7, the clampshell 200 also minimizes the tensile stresses and strains on the connection of the drop cable 164 to the bulkhead connector 150 within the hardened drop terminal 100. Each of the clampshells 200 has at least a groove 207 at least partially around a perimeter of an outer surface and a protruding tongue 203 on an opposite side, where the groove 207 and the tongue 203 are a second portion of a securing mechanism. The groove 207 includes a flat surface 205 that accepts a protruding flat tongue 192 that extends from a sidewall and into a slot 190 in the bottom wall 124. The protruding tongue 203 is positioned within a groove 195 in a sidewall that also partially defines the slot 190, where the tongue 203 and the groove 195 have cooperating flat surfaces, where the tongue 192 and the groove 195 are a portion of a securing mechanism.

The interaction of the flat surfaces of the tongue 203 in the clampshell 200 with the groove 195 in the slot 190 along with the interaction of the groove 207 in the clampshell 200 with the tongue 192 in the slot 190 prevent rotation of the clampshell 200 relative to the base unit 110 and, therefore, minimize rotational stress and strain on the connection between the drop cable 164 and the bulkhead connector 150 on the second side 154 of the bulkhead connector 150. The interaction of the tongues 203 and 192 with the groves 195 and 207, respectively, also prevent the clampshell 200 from being pulled from the slot 190 and therefore limits the tensile stresses on the connection between the drop cable 164 and the bulkhead connector 150. While a tongue and groove connection between the clampshell 200 and the slot 190 are illustrated, other securing mechanisms besides the tongue and groove securing mechanism are also contemplated.

As illustrated, the base unit 110 includes four slots 190 that are configured to accept two clampshells 200 in each slot 190. Each slot 190 has substantially parallel side walls and arcuate distal end wherein a proximal opening is configured to accept a clampshell 200. However, the number of slots 190 and clampshells 200 that are utilized can be modified to meet the requirements of any particular application.

As illustrated, three of the slots 190 each engage two clampshells 200 while another slot 190 engages a drop cable 164 with a different connector. However, it is contemplated that drop cables 164 secured to the clampshells 200 can be utilized in all of the slots.

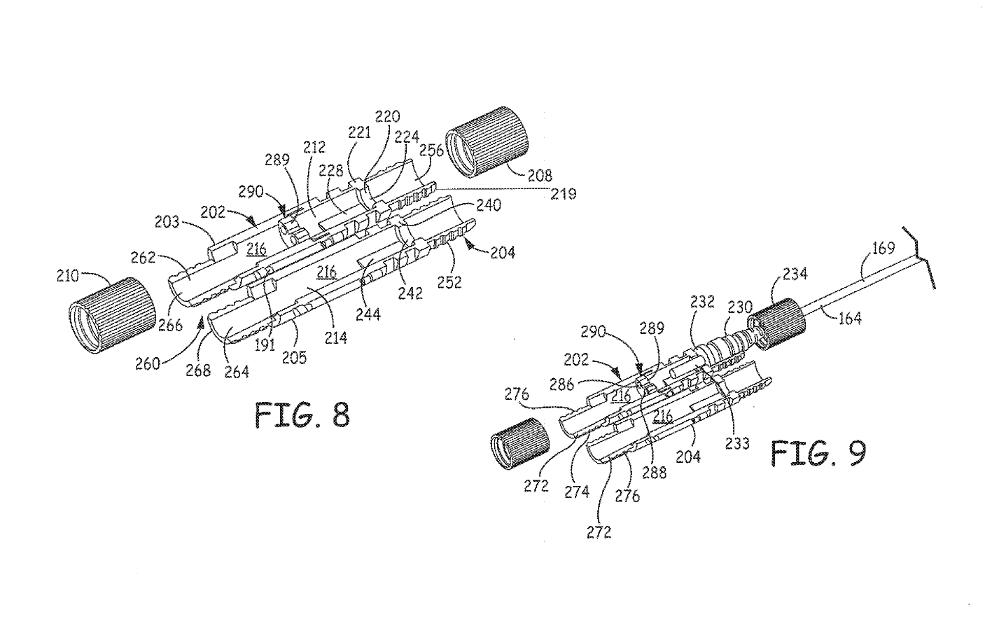

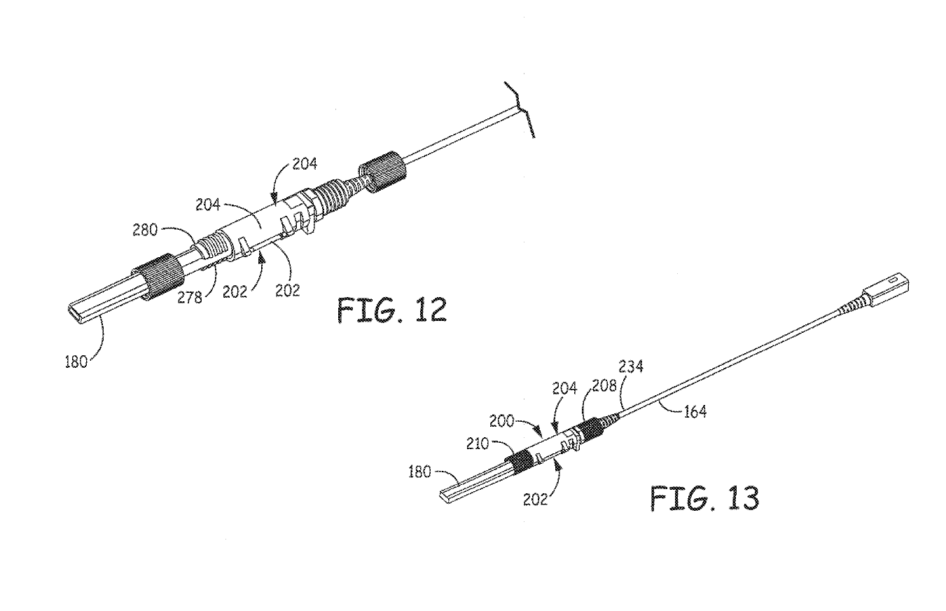

Referring to FIGS. 7-13, the clampshell 200 includes a base 202 and a cover 204 that are attached with a hinge 206. The hinge 206 can include a single hinge pin 191 as illustrated in FIGS. 8-11 or can include spaced-apart hinge pins 193 as illustrated in FIG. 7. The hinge 206 allows the base 202 and the cover 204 to be positioned in a closed position as illustrated in FIGS. 7, 12 and 13 and in an open position as illustrated in FIGS. 8-11. In the closed position, top and bottom threaded nuts 208 and 210 are threadably secured to outer surface portions of the base 202 and the cover 204 to force the base 202 and the cover 204 together to form a water resistant seal there between.

Referring to FIGS. 8-11, the base 202 and the cover 204 are illustrated in the open position where interior surfaces 212 and 214 of the base 202 and the cover 204 define an interior cavity that is configured to accept an interior sheathed portion 226 and an exterior sheathed portion 181 of the distribution fiber optic drop cable 164.

The interior of the base 202 includes a shoulder 220 that extends from a left edge 219 to a right edge 221. The shoulder 220 includes an arcuate cutout 224 that is sized to accept the interior sheathed portion 226 of the drop cable 164. Extending from an interior surface of the shoulder 220 is a raised platform 228 that is configured to prevent the interior sheathed portion 226 from flexing towards the interior surface 212 of the base 202.

The interior sheathed portion 226 of the drop cable 164 is retained in the clampshell 200 by inserting the interior sheathed portion 226 of the drop cable 164 through a through bore 232 in a strain relief 230. The strain relief 230 is constructed of a flexible and compressible polymeric material and has a frusto-conical configuration where a larger diameter end 233 is positioned proximate the shoulder 220 and a smaller diameter end 234 extends beyond a top end of the base 202.

The cover 204 has a similar construction proximate a bottom end as that of the top end of the base 202 where the cover 204 includes a similarly configured shoulder 240 to that of the shoulder 220 where the shoulder 240 includes a cutout 242 with substantially the same radius as the cutout 224 where the cutouts 224 and 242 form a through bore that is sized to accept and pass the interior sheathed portion 226 of the fiber optic drop cable 164 therethrough. The cover 204 also includes a raised platform 244 that also prevents excessive flexing of the interior sheathed portion 226 of the fiber optic drop cable 164.

The larger end 233 of the strain relief 230 engages the shoulder 240, which prevents the strain relief 230 from being inserted into the interior cavity 216 beyond the shoulder 220. In the closed position, the shoulder 240 also engages the larger end 233 of the strain relief 230 and prevents the strain relief 230 from being inserted further into the interior cavity 216.

A diameter of the strain relief 230 at the larger end 233, and extending a distance toward the smaller end 234, is greater than the diameter of the inner surfaces of the base 202 and the cover 204 at the top end when positioned in the closed position. When in the closed position, the base 202 and the cover 204 have cooperating threaded surfaces 250 and 252 in the outer surfaces 203 and 205, all respectively.

The cooperating threaded surfaces 250 and 252 accept the top threaded nut 208 which forces the cover 204 and the base 202 together and compresses the portion of the strain relief 230 within the interior cavity 216. As the strain relief 230 compresses, the through bore 232 constricts which causes a frictional engagement between the strain relief and the interior sheathed portion 226 of the drop cable 164. The strain relief 230 therefore provides strength to the interior sheathed portion 226.

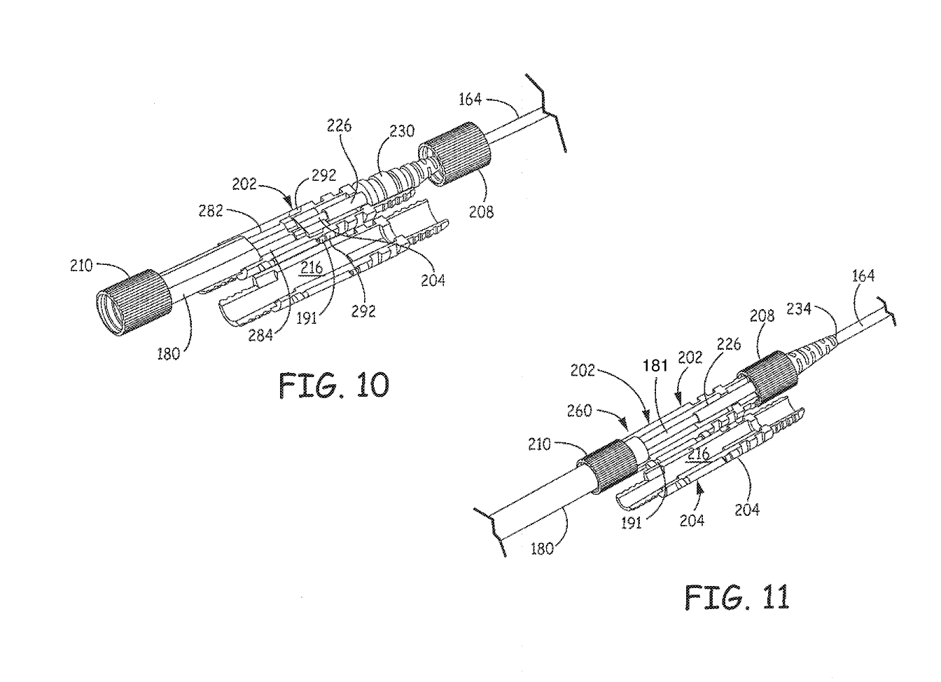

A bottom end 260 of the clampshell 200 is configured to accept the portion 181 of the fiber optic drop cable 164 having a flat, heavy and rigid outdoor jacket 180 (as illustrated in FIG. 10) or a fiber optic drop cable 164 having a round, heavy and rigid jacket 180 (as illustrated in FIG. 11). Bottom ends 262 and 264 of the base 202 and the cover 204 have arcuate portions 266 and 268 with cooperating threaded outer surfaces 270 and 272, all respectively. The bottom ends 262 and 264 include cutout portions 274 and 276 that, when the base 202 and the cover 204 are placed in the unsecured closed position, form slots 278 and 280, all respectively.

Referring to FIGS. 9, 10 and 12, the slots 278 and 280 allow a fiber optic drop cable 164 with a flat, exterior jacket 180 to be positioned with the interior of the clampshell 200 through the bottom end 260 such that the portion 181 of the flat jacket 180 can be transitioned to the interior jacketed portion 226 of the drop cable 164. The jacket 180 is removed from the drop cable 164 to expose left and right strengthening members 282 and 284 along with a length of the bare fiber optic cable 164. The portion 181 transitions to the interior jacketed portion 226 and the left and right strengthening members 282 and 284 are positioned through apertures 286 and 288 of a retaining member 290. The strengthening members 282 and 284 are locked into place with locking members 292 and 294 that frictionally engage and retain the drop cable 164 in the clampshell 200. The retaining member has an indent 289 that supports the portion 181 of the fiber optic cable 180.

With the strengthening members 282 and 284 retained to the base 202 with the locking members 292 and 294 and the portion 181 of the outdoor jacket 180 transitioned to the interior jacketed portion 226 of the drop cable 164, the cover 202 is closed and the bottom nut 210 along with the top nut 208 threadably engage the threaded outer surfaces of the base 202 and the cover 204. The engagement of the nut 208 was previously discussed. The engagement of the nut 210 with the outer surfaces of the base 202 and the cover 204 constrict the opening at bottom end 260 and frictionally engage the jacket 180 to retain the portion 181 within the clampshell 200.

Referring to FIG. 11, the bottom end 260 is also configured to accept a fiber optic drop cable 164 with a round jacket 180, which typically does not have reinforcing members. The exterior jacket 180 is removed from the portion 181 to expose the fiber optic cable 164 within the interior cavity 216. The exposed fiber optic cable 164 is sheathed with a length of an interior jacket 226 that is more lightweight and flexible relative to the exterior jacket 180. The clampshell 200 therefore transitions the fiber optic cable from the exterior, heavy and rigid jacket 180 to the interior, lightweight and flexible jacket 226 which allows the fiber optic drop cable 164 to be more easily manipulated.

With the cover 204 in a closed position relative to the base 202, a diameter of the round jacket 180 is larger than a diameter of the opening at the bottom 260. As the nut 210 threadably engages the threaded outer surfaces, the base 202 and the cover 204 are forced together, which constricts the opening at the bottom end 260 such that the base 202 and cover 204 frictionally engage the round jacket 180 to retain the portion 181 of the drop cable 164 within the clampshell 200.

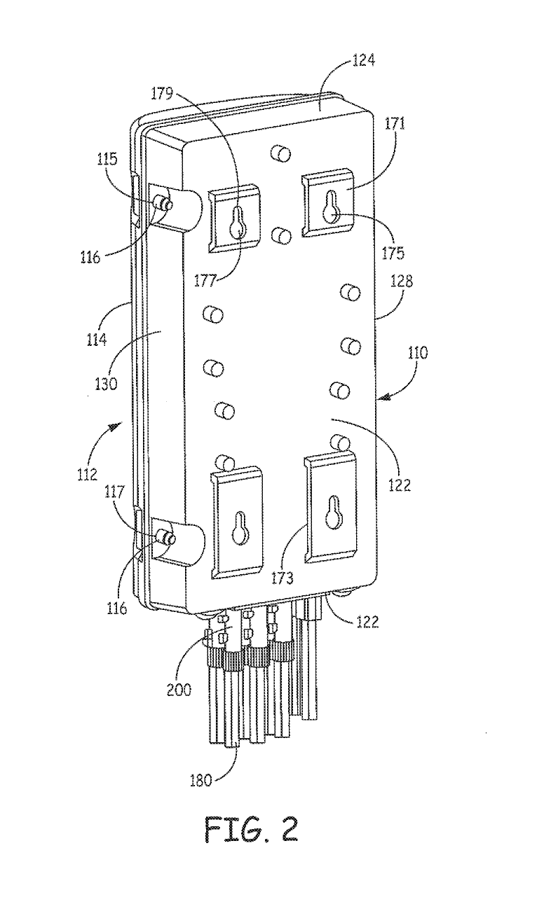

Referring back to FIG. 2, a plurality of spaced apart mounting plates 171 extend from the back wall 122 and define a space 173 between the mounting plates 171 and back wall 122. Each of the plurality of mounting plates 171 include an aperture 175 having a first portion 177 that is substantially circular and configured to accept a head of a bolt or screw (not shown) where the bolt or screw retained to a selected object, such as a pole or a telecommunications pedestal. Each aperture 175 includes a second portion 179 configured as a slot that is in communication with the substantially circular first portion 177. The slot shaped second portion 179 is configured to accept a shaft of the bolt or screw. A width of the slot shaped second portion 179 is less than a diameter of the head and prevents the head of the bolt or screw from passing therethrough. To mount the hardened drop terminal 100 to a surface, the bolts or screws are partially inserted into the surface such that a portion of the shaft extends from the surface. The first portions 177 of each of the plurality of apertures 175 are positioned about the heads of the screws or bolts until the heads of the screws and bolts are located within the space 173 between the mounting plates 171 and the back wall 124.

The hardened drop terminal 100 is then moved to position the second slot shaped portions 179 about the shaft of the bolt or screw, such that the head of the screw or bolt cannot pass therethrough and thereby mount the hardened drop terminal 100 to the surface. To remove the hardened drop terminal 100 from the surface, the hardened drop terminal 100 is raised to position the screw or bolt head in alignment with the circular first portion 177 of the aperture 175. The hardened drop terminal 100 is the moved away from the surface until each of the mounting plates 171 is spaced from each of the heads of the screws or bolts.

A best illustrated in FIGS. 3 and 4, support pins 302 and 304 extend from the back wall 122 and pivotally support a splice plate 300. The splice plate 300 provides a work platform within the hardened drop terminal 100 to mechanically splice or fuse splice fiber optic cables together or to secure a connector to an end of a fiber optic cable, such as when the individual fiber optic cables of the backbone or main fiber optic cable are connected to the bulkhead connector 150, either by terminating the cable at the hardened drop terminal 100 or when utilizing a mid-sheath entrance.

The splice plate 300 includes a top spool 306 and a bottom spool 308 to manage the unjacketed or unsheathed fiber optic cables. The splice plate 300 includes two storage tools 310 and 312 that are configured to retain the splices for the installer. While a splice tray 300 is a convenient tool for the installer, the splice plate 300 is not necessary to practice the present disclosure.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, in various embodiments, the hardened drop terminal can be made from materials other than plastic. Further, the various components can be arranged in different ways than those specifically illustrated. Other examples of modifications of the disclosed concepts are also possible, without departing from the scope of the disclosed concepts.

What is claimed is:

1. A fiber optic cable network interface device comprising:
a base unit defining an interior cavity and comprising a cable entrance port configured to provide entrance to the interior cavity of the base unit for a main fiber optic cable having a plurality of individual fiber optic cables secured therein and at least one cable exit port configured to provide entrance to the interior cavity of the base unit for at least one distribution fiber optic cable wherein surfaces defining the at least one cable exit port comprise a first portion of a retaining mechanism;
a bulkhead connector retained within the interior cavity of the base unit wherein the bulkhead connector includes a plurality of receptacles on a first side to accept one or more of the plurality of individual fiber optic cables of the main fiber optic cable and a plurality of connectors on a second side configured to accept one or more of the at least one distribution fiber optic cables on a central office side of the fiber optic network; and
a clampshell configured to engage the at least one distribution fiber optic cable and transition a jacketing of the at least one distribution fiber optic cable from an interior jacket to an exterior jacket wherein an exterior surface of the clampshell comprises a second portion of the retaining mechanism such that when the clampshell is positioned within the at least one cable exit port, the first and second portions of the retaining mechanism engage such that the clampshell resists rotation and pulling forces on the at least one distribution fiber optic cable at the connection with one of the connectors on the second side of the bulkhead connector.

2. The fiber optic cable network interface device of claim 1 and wherein the at least one cable exit comprises a slot with substantially parallel first and second side walls and an open end configured to accept the clampshell therethrough.

3. The fiber optic cable network interface device of claim 2 and wherein the first portion of the securing mechanism comprises:
a groove in the first sidewalls; and
a tongue extending from the second sidewall.

4. The fiber optic cable network interface device of claim 3 wherein the second portion of the securing mechanism on the clampshell comprises:
a groove in an exterior surface of the clampshell, the groove configured to engage the tongue extending from the second sidewall of the slot; and
a tongue extending from the exterior surface of the clampshell, the tongue configured to engage the slot within the first sidewall of the slot.

5. The fiber optic cable network interface device of claim 1 and wherein the clampshell comprises:
a first end configured to accept the at least one distribution fiber optic cable jacketed with the exterior jacket; and
a second end configured to accept the at least on distribution fiber optic cable jacketed with the interior jacket.

6. The fiber optic cable network interface device of claim 1 and wherein the clampshell comprises a housing, the housing comprising:
a first portion having first and second end and wherein an exterior surface of the first portion proximate the first and second ends comprise threads; and
a second portion hingedly attached to the first portion, the second portion having first and second ends and wherein an exterior surface of the second portion proximate the first and second ends comprise threads and wherein the first and second portions are hingedly movable from a first position wherein the at least one distribution fiber optic cable can be positioned within the clampshell and a second position wherein the first and second portions are positioned about the at least one distribution fiber optic cable.

7. The fiber optic cable network interface device of claim 6, and wherein the clampshell further comprises:
a first nut having a threaded through bore sized to pass the at least one distribution fiber optic cable with the exterior jacket therethrough and configured to engage the threaded exterior surfaces proximate the first ends of the first and second portions of the housing when in the second position; and
a second nut having a threaded through bore sized to pass the at least one distribution fiber optic cable with the interior jacket therethrough and configured to engage the threaded exterior surfaces proximate the second ends of the first and second portions of the housing when in the second position.

8. The fiber optic cable network interface device of claim 7 and wherein the clampshell further comprises a strain relief, the strain relief comprising:
a main body constructed from a flexible and compressible material, the main body having a frusto-conical outer surface from a first end and a second end and comprising a through bore from the first end to the second end wherein the through bore is configured to accept the interior jacketed at least one distribution fiber optic cable therethrough wherein when the second nut is threadably secured to the second ends of the first and second portions of the housing the main body is compressed which results in a frictional engagement between the main body and the interior jacketed at least one distribution fiber optic cable.

9. The fiber optic cable network interface device of claim 5 and wherein the first end comprises:
a first segment having a first side surface and a second side surface comprising an arcuate inner surface; and
a second segment having a first side surface and a second side surface comprising an arcuate inner surface; wherein the first and second side surface of the first and second portions are spaced from each other and define opposing slots configured to accept a substantially flat at least one distribution fiber optic cable with and an exterior jacket and wherein the arcuate inner surfaces are configured to accept a substantially round at least one distribution fiber optic cable with an exterior jacket.

10. The fiber optic cable network interface device of claim 1 and wherein the base unit comprises:
a back wall having a perimeter; and
sidewalls extending from the perimeter wherein the back wall and sidewalls define the interior cavity and wherein the bulkhead connector is spaced a distance from the back wall.

11. The fiber optic cable network interface device of claim 10 and further comprising a clamp secured to the back wall wherein the clamp is configured to engage and retain the main fiber optic cable.

12. The fiber optic cable network interface device of claim 10 and further comprising:
a first reel attached to the back wall, the first reel configured to retain a portion of the main fiber optic cable; and
a second reel attached to the back wall and spaced apart from the first reel, the second reel configure to retain a portion of the at least one distribution fiber optic cable.

13. A fiber optic cable network interface device comprising:
a base unit defining an interior cavity and comprising a cable entrance port configured to provide entrance to the interior cavity of the base unit for a main fiber optic cable having a plurality of individual fiber optic cables secured therein and a plurality of cable exit ports configured to provide entrance to the interior cavity of the base unit for a plurality of distribution fiber optic cables wherein surfaces defining each of the plurality of cable exit port comprise a first portion of a retaining mechanism;
a bulkhead connector retained within the interior cavity of the base unit wherein the bulkhead connector includes a plurality of receptacles on a first side to accept one or more of the plurality of individual fiber optic cables of the main fiber optic cable and a plurality of connectors on a second side configured to accept one or more of the plurality of distribution fiber optic cables on a central office side of the fiber optic network; and
a plurality of clampshells, each clampshell configured to engage one of the plurality of distribution fiber optic cables and transition a jacketing of one of the plurality of distribution fiber optic cables from an interior jacket to an exterior jacket wherein an exterior surface of each the clampshell comprises a second portion of the retaining mechanism such that when the clampshell is positioned within one of the plurality of cable exit ports, the first and second portions of the retaining mechanism engage such that the clampshell resists rotation and pulling forces on one of the plurality of distribution fiber optic cables at the connection with one of the connectors on the second side of the bulkhead connector.

14. The fiber optic cable network interface device of claim 13 and wherein each of the plurality of exit ports is configured to accept one or more clampshell.

15. The fiber optic cable network interface device of claim 14 and wherein each of the plurality of exit ports comprises a slot with substantially parallel first and second side walls and an open end configured to accept the clampshell therethrough.

16. The fiber optic cable network interface device of claim 15 and wherein the first portion of the securing mechanism comprises:
a groove in the first sidewalls; and
a tongue extending from the second sidewall.

17. The fiber optic cable network interface device of claim 16 wherein the second portion of the securing mechanism on each of the plurality of clampshells comprises:
a groove in an exterior surface of the clampshell, the groove configured to engage the tongue extending from the second sidewall of the slot; and
a tongue extending from the exterior surface of the clampshell, the tongue configured to engage the slot within the first sidewall of the slot.

18. The fiber optic cable network interface device of claim 13 and wherein the each of the plurality of clampshells comprises:
a first end configured to accept the at least one distribution fiber optic cable jacketed with the exterior jacket; and
a second end configured to accept the at least on distribution fiber optic cable jacketed with the interior jacket.

19. The fiber optic cable network interface device of claim 13 and wherein each of the plurality of clampshells comprises:
a housing comprising:
a first portion having first and second end and wherein an exterior surface of the first portion proximate the first and second ends comprise threads; and
a second portion hingedly attached to the first portion, the second portion having first and second ends and wherein an exterior surface of the second portion proximate the first and second ends comprise threads and wherein the first and second portions are hingedly movable from a first position wherein the at least one distribution fiber optic cable can be positioned within the clampshell and a second position wherein the first and second portions are positioned about the at least one distribution fiber optic cable;
a first nut having a threaded through bore sized to pass the at least one distribution fiber optic cable with the exterior jacket therethrough and configured to engage the threaded exterior surfaces proximate the first ends of the first and second portions of the housing when in the second position; and
a second nut having a threaded through bore sized to pass the at least one distribution fiber optic cable with the interior jacket therethrough and configured to engage the threaded exterior surfaces proximate the second ends of the first and second portions of the housing when in the second position.

20. The fiber optic cable network interface device of claim 19 and wherein each of the plurality of clampshells further comprises a strain relief, the strain relief comprising:
a main body constructed from a flexible and compressible material, the main body having a frusto-conical outer surface from a first end and a second end and comprising a through bore from the first end to the second end wherein the through bore is configured to accept the interior jacketed at least one distribution fiber optic cable therethrough wherein when the second nut is threadably secured to the second ends of the first and second portions of the housing the main body is compressed which results in a frictional engagement between the main body and the interior jacketed at least one distribution fiber optic cable.
